(19) United States
(12) Patent Application Publication
(10) Pub. No.: US 2026/0097885 A1
(43) Pub. Date: Apr. 9, 2026

(54) CONTAINER AND CLOSURE SYSTEMS WITH FLAME MITIGATION

(71) Applicant: Rieke LLC, Auburn, IN (US)

(72) Inventors: Ronald KIERAS, McHenry, OH (US); Mike WOODCOCK, Auburn, IN (US)

(21) Appl. No.: 19/349,122

(22) Filed: Oct. 3, 2025

Related U.S. Application Data
(60) Provisional application No. 63/703,294, filed on Oct. 4, 2024.

(51) Int. Cl. B65D 25/38; A62C 3/06; B65D 25/42

(52) U.S. Cl. CPC B65D 25/385; A62C 3/065; B65D 25/42

(57) ABSTRACT

Flame mitigation devices meeting all applicable regulatory requirements are described. The device includes a slotted connector and a venting support tube, with systems described to include a container with an elongated pouring spout. Additional aspects include a series of container sections each having a flame mitigation device as described above.

### CROSS REFERENCE TO RELATED APPLICATIONS

This application claims priority to U.S. provisional patent application 63/703,294 filed on Oct. 4, 2024, which is incorporated by reference herein.

### TECHNICAL FIELD

The present invention relates generally to a disposable, pre-filled storage container for flammable fuels and liquids having a flashpoint below 60° C. (140° F.) an attachable closure having an integrally formed or permanently affixed flame mitigation device disposed within the outlet to minimize or prevent the potential of flame jetting or container rupture.

### BACKGROUND

Portable fuel containers are widely used for the transportation, storage, and dispensing of fuels, fire starters, additives for internal combustion engines, and other flammable liquids (i.e. liquids having a flashpoint below 60° C. (140° F.)). Often, these liquids are sold in disposable—and sometimes reusable—pre-filled, containers. Owing to their flammability, numerous statutory and regulatory requirements are imposed on manufacturers and sellers of such containers.

For example, the United States' Consumer Products Safety Commission has adopted or endorsed numerous standards published by ASTM International, including F3429; F3326; F2874; F2517; and F852. One of the primary areas for concern in this regard is to provide for a flame mitigation device. These usually take the form of a physical insert that prevents propagation of flames into or out of the container.

The flash point is the minimum temperature at which a liquid forms a vapor above its surface in sufficient concentration that it can be ignited, and the lower the flash point, the more easily that liquid can ignite. Liquids having a flash point of less than 100° F. are designated as “flammable,” while “combustible” liquids have a flashpoint at or above 100° F. Most existing and anticipated statutory/regulatory schemes seek to mitigate against the impact of sparks and flames by providing a barrier to prevent, suppress, or delay ignition of vapors inherent to all flammable and combustible liquids, and especially those confined in containers with a narrow neck or outlet.

U.S. Pat. Nos. 2,733,775; 8,029,667; 8,602,273; 9,126,067; 9,174,075; 9,205,292; 9,295,860; 10,029,132; 10,307,625; 10,737,127; 10,792,525; and 11,807,421 all describe various mechanisms to suppress, arrest, or mitigate flame and explosion events in containers and transportation vessels for flammable liquids and fluids. All of these patents are incorporated by reference herein as background for the design considerations, purposes, and challenges in this field. German publication DE149581A, Australian patent AU511081B, British publication GB707414A, and European patent EP2812275B1 are similarly informative.

Flame mitigation devices can rely on a variety of mechanisms. In some cases, fuel is captured in small apertures of a cup or screen within the container neck so that the vapor pressure of that entrained fuel prevents combustible ratios of air and fuel from existing at the container opening. Additionally or alternatively, the construction of the cup or screen is such that flames are quenched before they can travel beyond the cup/screen.

These flame mitigation devices must possess a construction that allows for filling of the container, possibly through the apertures in the device or by installing the device after filling is complete. In either instance, when installed, regulations require the flame mitigation device to remain permanently affixed to the container. Thus, the flame mitigation device must remain in place even when conditions within the container (e.g., internal pressure, high temperatures, etc.) might otherwise induce decoupling or degradation of the device itself.

As a final consideration, many consumer products companies have initiated sustainability campaigns whereby packaging contains certain percentages (i.e., at least 67% and up to 95% or even 100%) of post-consumer resins (PCR) or otherwise is compatible with PCR recycling systems. PCR resins may include (but is not limited to) certain grades of thermoplastics. Ideally, a single type of PCR resin is employed so that the closure can be introduced into recycling programs without the need to disassemble and/or separate parts, even in situations where the entirety of the closure might be comprised of recyclable materials (e.g., a plastic closure with a metal component must undergo disassembly and removal/sorting of such component to ensure that the metal does not foul the plastic recovery/recycling chain).

In view of the foregoing, a container with a closure permanently affixed after the container is initially filled is needed, particularly one relying on conventional neck finishes (i.e., having standard dimensions commonly used within the industry). More importantly, these containers must include a flame mitigation device meeting capable of meeting some or all of the aforementioned statutory/regulatory requirements. Finally, the entire assembly should be made of cost effective, sustainable, and recyclable materials.

### SUMMARY OF INVENTION

A flame mitigation device and system are contemplated. The device comprises two components: a slotted connector and venting support tube. Taken together, the device provides dual functionality by effectively metering the air and fuel passing through its slotted, tapered sidewall and perforated bottom plate (while also creating a physical barrier to prevent flashback) and by providing annular attachment to the container neck with sufficient strength to meet retention requirements (as established by the aforementioned standards and other applicable regulations). The venting support tube couples to the underside of the device proximate to the bottom plate. The tube is configured to prevent the device from being forced downward into the container by having an axial length sufficient to contact the bottom inside of the container. It is also understood that, owing to the axial length of the tube, fluid does not pass through the inner lumen of the tube during dispensing and, instead, the tube provides an airflow path.

The broader system includes a container having an elongated pouring spout. In some aspects, a dual chamber container has an arrangement in which two separate devices are disposed in discrete fluid containment sections with the sections connected by a flow tube at the bottom of the receiving section connected to an upper portion of the secondary (or pouring) section.

Specific reference is made to the appended claims, drawings, and description below, all of which disclose elements of the invention. While specific embodiments are identified, it will be understood that elements from one described aspect may be combined with those from a separately identified aspect. In the same manner, a person of ordinary skill will have the requisite understanding of common processes, components, and methods, and this description is intended to encompass and disclose such common aspects even if they are not expressly identified herein.

### DESCRIPTION OF THE DRAWINGS

Operation of the invention may be better understood by reference to the detailed description taken in connection with the following illustrations. These appended drawings form part of this specification, and any information on/in the drawings is both literally encompassed (i.e., the actual stated values) and relatively encompassed (e.g., ratios for respective dimensions of parts). In the same manner, the relative positioning and relationship of the components as shown in these drawings, as well as their function, shape, dimensions, and appearance, may all further inform certain aspects of the invention as if fully rewritten herein. Unless otherwise stated, all dimensions in the drawings are with reference to inches, and any printed information on/in the drawings form part of this written disclosure. Because the drawings are provided at scale, dimensional information and comparative ratios may be inferred, extrapolated, or otherwise obtained from the images in individual Figures.

In the drawings and attachments, all of which are incorporated as part of this disclosure:

FIG. 1 is a perspective, cross sectional view, taken along a central axis, of a single chamber flame mitigation system according to selected aspects of the invention.

FIG. 2 is a perspective of a dual chamber flame mitigation system according to selected aspects of the invention, with the front facings of the container shown in a semi-transparent state so as to provide views of the interior of each of the two chambers and the flame mitigation devices therein.

FIG. 3 is a cross sectional side view of the single chamber system shown in FIG. 1, with FIG. 3A being an isolated and enlarged view of callout 3A in FIG. 3.

FIGS. 4A and 4B are perspective, cross sectional diametric views, respectively speaking, of the slotted connectors shown in FIGS. 5A and 5B.

FIGS. 5A through 5D are perspective views of various aspects of the slotted connector used in the systems contemplated by FIGS. 1 and/or 2.

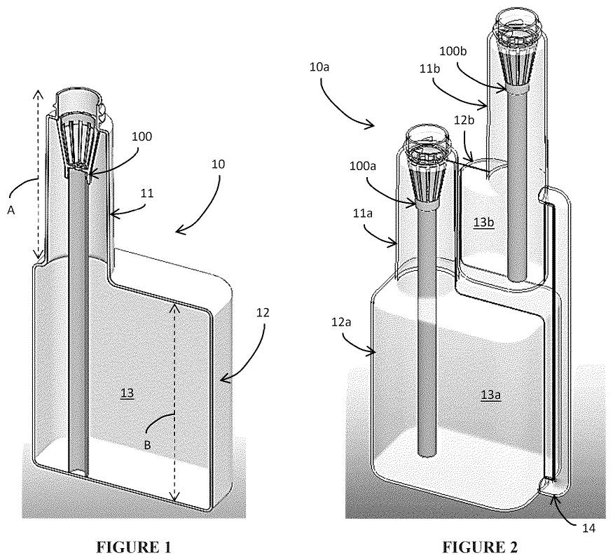

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. As such, the following description is presented by way of illustration only and should not limit in any way the various alternatives and modifications that may be made to the illustrated embodiments and still be within the spirit and scope of the invention.

As used herein, the words “example” and “exemplary” mean an instance, or illustration. The words “example” or “exemplary” do not indicate a key or preferred aspect or embodiment. The word “or” is intended to be inclusive rather an exclusive, unless context suggests otherwise. As an example, the phrase “A employs B or C,” includes any inclusive permutation (e.g., A employs B; A employs C; or A employs both B and C). As another matter, the articles “a” and “an” are generally intended to mean “one or more” unless context suggest otherwise.

It will be understood that components and elements here in may have tubular and/or cylindrical shapes, so axial may be synonymous with the height and/or vertical dimensions (as shown in the Figures and as will naturally occur when the system is installed in container that is resting on level ground). In the same manner, radial or transverse may be synonymous with the length and width in the corresponding horizontal dimensions. Ultimately, the context provided by the drawings can be used to inform any directional or comparative relationships of or between the components and elements.

Aspects of the invention are directed to devices that can be installed within the elongate neck(s) constituting the inlet and/or outlet of container so as to provide flame suppression and/or mitigation. The container may include a closure/cap that employs any number of additional features that are commonly encountered in this field, including but not limited to a screw fit arrangement between the cap and the closure to allow the closure to selectively removed and refitted. When fitted, the combination can form a watertight and/or hermetic seal. The initial removal of the cap from the closure engages, initiates, or otherwise enables the use of anti-counterfeiting, anti-tampering, authentication/verification, or other informational means as are known in this field.

These devices are installed through the opening of a container 10 having an elongated spout or pouring feature 11. “Elongated neck” (and similar terms, including spout) means that the container 10 possesses a discrete spout section 11 that protrudes axially away from the main body of the container, with that spout 11 extending at an axial height (A) that is at least one quarter or more as compared to the axial height (B) of the container's main body 12. Additionally, the main fluid reservoir 13 within the body 12, at its widest transverse plane, has a surface area that is at least twice as large—and up to five or even ten times larger—as compared to the smallest/narrowed transverse plane within the spout, usually at or immediately below the opening.

In some aspects, a dual chamber container 10a two elongated necks 11a, 11b associated with discrete body sections 12a, 12b. The respective reservoirs 13a, 13b are be coupled together in series, so that a fluid connector 14 is positioned at the bottom of the reservoir 13a to feed a middle or top portion of reservoir 13b (it being understood that, during dispensing, the connector 14 should be rotated downward toward the ground so that fluid flows into reservoir 13b and out of spout 11b). While not shown, the opening in each neck can be covered by a cap or closure that is rotatably removable and/or that remains permanently attached to the container itself, e.g., by way of a tether, hinge, or other similar means.

Each neck 11, 11a, 11b will be configured to receive and, after installation, permanently retain, a flame mitigation device 100. In the dual chamber container 10a, the devices 100a, 100b may be identical (which can realize manufacturing efficiencies) or selected aspects can be altered as described herein, possibly to accommodate different flow/pouring conditions or size constraints (to the extent the reservoirs 13a, 13b have different volumes or dimensions). Collectively, the use of device(s) 100 in container 10 or 10a constitutes a flame mitigation system as contemplated in its various aspects herein.

Significantly, the system, including all containers and devices, will be made completely from polymeric materials. In some aspects, a single polymeric material can and will be used so as to simplify manufacture and disposal/recycling of the system.

The device 100 is configured so as to be inserted through the opening in the spout 11. Thereafter, the slotted connector 110 couples to one or more features on the interior surfaces of the spout 11, while the venting support tube 120 ensures proper axial positioning and support. Thereafter, the device 100 remains permanently affixed so as to impart flame mitigation benefits. The axial dimensions of the connector 110 are such that the connector 110 remains fully within the volume of the spout 11 after the device 100 is installed.

The slotted connector 110 is shaped like a tube or funnel, with a wide opening at the top tapering to a smaller inner diameter at the bottom. Generally speaking, the height of the connector 110 will be larger than its outer diameter along any portion of the connector. It will also include at least four main features: a retention element 111 at or near its top edge imparting container retention feature CR, slotted sidewalls 112 extending downward and sloping inward imparting a side metering feature SM, a perforated plate 113 obstructing the inner channel of the funnel near its bottom end, and a tube retention feature 114 positioned beneath plate 113 imparting tube retention features TR. All four of elements 111, 112, 113, 114 are formed integrally as a single piece, so as to make the connector 110 amenable to manufacture by way of molding.

The retention element 111 possesses both the largest inner diameter RID and outer diameter ROD of any of the features in the connector 110. Significantly, that outer diameter is selected to cooperate with the inner diameter of the opening in the spout 11 so that the device 100 may be installed but then remain coupled to the spout. In this regard, the use of polymers in the construction of the device 100 is particularly helpful because these materials possess greater flexibility and resilience in comparison to metallic components (with selection of a polymeric container allowing for similar benefits). In some aspects, the retention element 111 can be configured to have an angled bottom facing and/or to include gaps along at its outer-most periphery to facilitate force-fitting and installation into the spout 11 (see FIGS. 4A and 4B).

In some aspects, element 111 is a radially extending flange 111a, that is aligned in a plane that is parallel to the perforated plate 113. In other aspects, the radial flange 111a may be oriented at an acute angle, relative to plate 113, so that element 111 has a frusto-conical shape. In either instance, the radial flange 111a is solid with an axial thickness of this flange may be constant or it may taper or possess discrete and differing regions (as seen in the cross section of FIG. 4A) so as to be thickest around the center and gradually thinner at its outer periphery.

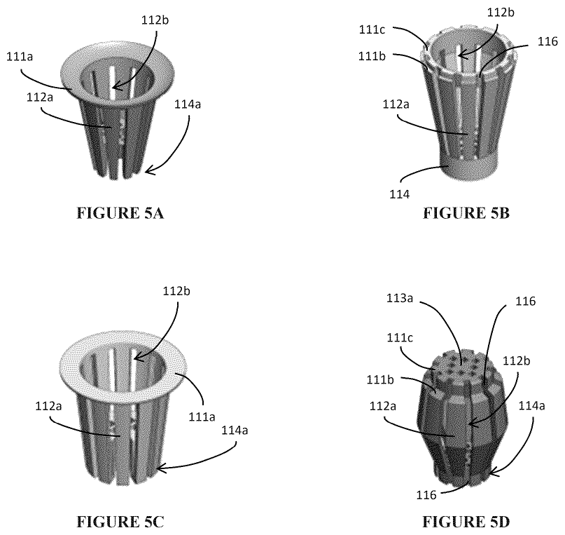

In yet another aspect, retention element 111 comprises an inset ledge 111b (as best seen in FIGS. 4B, 5B, and 5D). Here, in place of outwardly extending flange, a ledge 111b extends inwardly, with an upper sidewall 111c extending axially upward from the ledge's horizontal (or acutely angled) planar surface. The slotted pattern provided on sidewalls 112 (described below) is carried axially upward into the ledge 111b and/or upper sidewall 111c. In some aspects, the slotted pattern on these elements constitutes grooves, rather than complete through holes, as this arrangement provides for greater rigidity and strength as may be required to couple the element 111 to the spout 11.

Coupling features can formed on any of the periphery and/or upper facings of the flange 111a, on the surfaces of the ledge 111b or upper sidewall 111c that interface/abut with the interior facings of the spout 11, and as part of the grooves or interstices to the extent the slotted pattern carries onto any of the aforementioned aspects of retention element 111. Coupling can be by way of slot and flange, bead and groove, or other snap-fittings (with corresponding features on the interfacing surfaces of element 111 an interior facing of spout 112, with the further understanding that the resulting coupling of the element 111 and spout 11 must be sufficiently strong to pass the necessary tests for flame mitigation.

The element 111 defines the widest inner diameter of the connector 110. Except for the aspect depicted in FIG. 5D, element 111 also constitutes the largest outer diameter of the connector 110. Further, the coupling elements provided on element 111 must be arranged around a circumference that matches the inner diameter of the spout 11. Lastly, the element 111 will be integrally formed at the top periphery of the slotted sidewalls 112.

The slotted sidewalls 112 define a narrowing funnel with solid axial members 112a spaced apart to form elongated apertures 112b (i.e., slots). The comparative size of the solid vs. open portions in sidewall 112 are selected to allow for passage and smooth pouring of liquids and more viscous fluids through the apertures while also metering the amount return air that can pass through (understanding that additional metering is provided to the extent air also passes through the perforated plate 113). In this manner, flashback conditions are minimized.

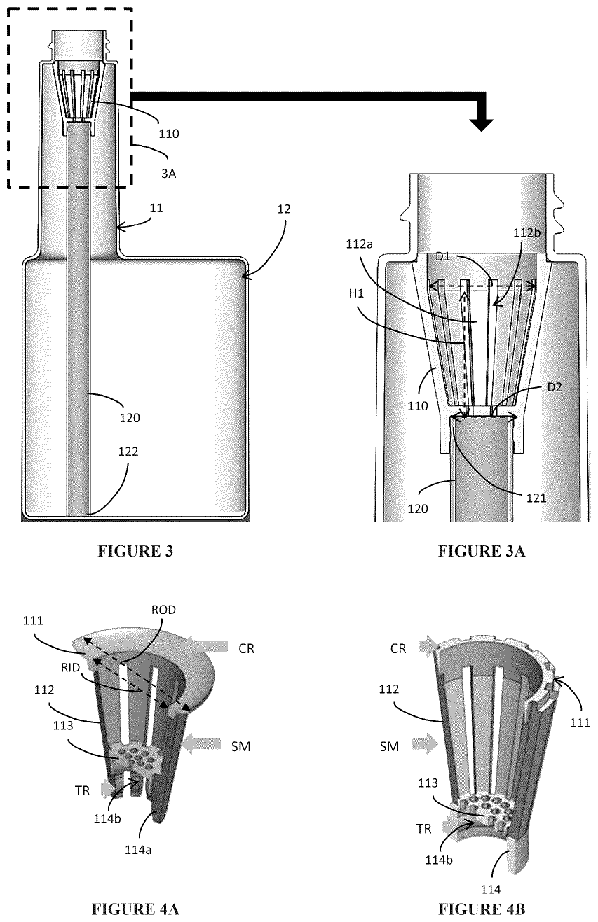

The solid members 112a extend down from the retention element 111 at an angle relative to the vertical axis of the venting support tube 120. This arrangement insures that the inner diameter D1 at the retention element 111 (and/or its intersection with the sidewalls 112) will be larger than the inner diameter D2 immediately above the perforated plate 113. In some aspects, the ratio of D2/D1 is between 0.565 and 0.7.14, with a more preferred range of between 0.591 and 0.667 and the depicted arrangement in FIG. 3A being 0.636. Other ranges are possible, although these are believed to provide the best flame mitigation performance.

Similar, optimal relationships exist with respect to the height of the aperture, as measured along vertical axis and labeled as H1 in FIG. 3A, from the bottom horizontal edge of an aperture up to the plane in which the horizontal edge of that same aperture. Here, the most preferred value of H1/D1 is 1.181, with a additional, useful ranges of 0.920 to 1.286 and 1.136 to 1.238.

In one aspect, the apertures 112b/void areas occupy less surface area/volume in comparison to the solid members 112a within the tapered section of sidewall 112. The solid portions may have be about no more than double or triple the volume, surface area, and/or radial spacing (i.e., the arc along the circumference that could be characterized as the width of each member) in comparison to the aperture/void areas. In a preferred aspect, the surface area within the sidewall 112 that is occupied by void space (i.e., open) should be between 50% to 70% relative to the corresponding surface area in that same region occupied by solid members.

The open areas within the sidewalls can also be comparatively expressed relative to the opening defined at the inner diameter at the very top edge/opening of retention element 111 (e.g., see D1 in FIG. 3A). Here, the cumulative void area in the sidewalls 112 will be less than the open/void area defined across the top edge/opening. In some aspects, the cumulative void area in the sidewalls and bottom plate should be between 80% to 95% of that created in the pouring area (i.e., the mouth of the funnel, which corresponds to the area of the inner diameter in the lumen defined by the retention element 111).

The solid members 112a should have similar or identical dimensions relative to one another, as should the apertures 112b, so as to provide for a uniform structure that can be installed in any orientation. Notably, the wall thickness in the retention element 111 may be the same or thicker than that in the solid member portions 112a of the sidewall 112.

In one aspect, the solid members 112a extend in a straight line. Because the members 112a conform to the circumferences defined by 111 at the top and 114 at the bottom, the members will have a curved shape in the horizontal/radial plane. When viewed in a vertical/axial plane (as shown in FIG. 3A), the members can present with a more pronounced trapezoidal shape to minimize variation in the width in comparison to the apertures 112b.

Alternatively, it is possible to shape members 112a as shown in FIG. 5D to initially extend outward on a straight line, so long as they bend inward so that D1 remains greater than D2. In this particular aspect in FIG. 5D, a second perforated plate 113a extends across the top opening of the connector 110 by extending horizontally inward from the upper sidewall 111c. In some aspects, plate 113a could be used in embodiments relying on a flange 111a, in which case plate 113a effectively acts as an inward extension of that flange. Unlike perforated plate 113, the perforations in plate 113a must be sized and provided in sufficient number to accommodate fluid flow through the plate 113a. For fluids exhibiting slower flow properties (e.g., higher surface tension and/or viscosity) in comparison to air, plate 113a will have a greater amount of cumulative void area (in the form of larger perforations and/or a greater number of perforations) as compared to plate 113.

In order to attain the desired flame mitigation characteristics, it is necessary to provide for a plurality of apertures 112b, preferably spaced apart evenly and sized/dimensioned similarly and, more preferably, identically. In the depicted aspects, between 10 to 12 apertures are used. It is believed at least 8 should be provided, with an upper limit dictated by the surface tension and viscosity of the fluid (it being understood these traits may impede the flow of fluid through apertures with small dimensions), as well as the capabilities and limitation of the molding or other manufacturing process used to construct the slotted connector 110. In some aspects, the upper limit is less than or equal to 20 and, more preferably, less than or equal to 16. The apertures 112b should extend from immediately at or above the horizontal plane occupied by the perforated plate 113.

Similar to retention element 111, the apertures may carry into the surface and/or structure of the tube retention feature 114. As seen in modified tube retention feature 114a, the apertures would present as outer surface grooves positioned around the circumference of perforated plate 113 and, in some aspects, those grooves 116 would extend all the way to the bottom end of the connector 110 (as seen in FIG. 5D). In other aspects, the apertures in modified tube retention feature 114a resume as through-holes when carried down below the elevation of plate 113 (as in FIGS. 5A and 5C). As seen in FIG. 5B, the apertures might cease at the plate 113, so that the outer surface of the tube retention feature 114 is solid and essentially smooth. In all cases, the outer and inner diameter of tube retention feature 114, 114a will both be smaller than the corresponding outer and inner diameters in retention element 111.

The inner surface of tube retention feature 114, 114a is dimensioned and configured to couple to the outer surface of the venting support tube 120. While it may be possible for the tube 120 to coaxially receive retention feature 114, 114a along the tube's inner surface (i.e., opposite of what is depicted), arranging the elements so that feature 114, 114a coaxially receives the top end of the tube 120 allows the upper edge 121 of the tube to abut and/or engage the underside of plate 113, thereby providing greater support for axial loads. When the tube 120 is received within feature 114, 114a, a coupling feature 114b is provided on the surfaces forming the inner facing of that feature. As shown in the FIGS. 4A and 4B, coupling feature 114b may be a bead and groove style connection, although other arrangements for coupling are possible.

The perforated plate 113 is positioned across the inner lumen of the connector 110 immediately below where the slotted apertures 112b terminate (although, as noted above, the exterior surfaces on the outside of the connector 110 may include grooves). The plate 113 is a solid member, preferably with similar or greater thickness in comparison to that of the solid members 112a. Apertures penetrating completely through the plate 113 are formed as a series of round and/or polygonal holes arranged in a regular pattern across its entire surface area. In some aspects, the open surface area comprising void space/apertures along the top surface of the plate 113 will be about 30% to 50% in comparison to that occupied by solid material (i.e., blocked).

While not intending to be bound strictly by a theory of operation, the gradual reduction of open vs. solid area progressing from the top to the bottom of the funnel that is formed by the connector 110 is believed to play an important role in flame mitigation. The specific, comparative combinations of open vs. blocked portions arranged along the top, sidewalls, and bottom plate contribute to flame mitigation performance. However, the precise amount of open space will be influenced by the fluid and its propensity to exhibit surface tension relative to the material from which the connector is constructed.

Venting extension tube 120 serves several critical features within all of the aspects of the flame mitigation systems and devices contemplated herein. First, because the tube is specifically dimensioned to abut the connector 110 at its top edge 121 and the bottom of the container at its lower edge 122, the tube 120 provides structural support against any downward axial force that might otherwise dislodge and interrupt the coupling of retention element 111 to the inner surface/features on the spout 11. Therefore, the axial length of the venting support tube 120 is specific to the container in which it will be used, although an advantage of the disclosed system (which relies on connector 110 being coupled to tube 120) is that the slotted connector 110 can be mass produced and thereafter coupled to an appropriately sized tube 120.

It may be possible for the end user to obtain tube stock which would cut to appropriate length. In some aspects, the end user would alternate between a straight cut (i.e., orthogonal to the outer axial surface of the tube) and a dimensioned cut (i.e., provided at a slight angle or by relying on a crenelated or wavy edge) so that the dimensioned cut-end of the resulting tube 120 would serve as bottom edge 122.

The second feature of venting support tube 120 is to provide a return air flow path into the internal container volume during dispensing. That is, tube 120 will not transport fluid and, instead, it serves as a barrier so that fluid flows toward the sidewalls 112 of the slotted connector 110. Thus, the tube must be solid and impervious to fluid flow from the top edge 121 at least to the middle and, more preferably, almost all the way down to the bottom edge 122. At or near that bottom edge, apertures, slots, or other features can be provided to insure that air in the tube can pass into the interior volume of the container. If the bottom edge 122 forms a hermetic seal with the container, it is possible that dispensing will only occur in dosed amounts (e.g., the dispensed amount of fluid would be influenced by—or possibly not exceed—the internal volume of the tube because pressure differentials created during pouring/dispensing between the ambient environment and the internal volume would eventually impede gravity-induced fluid flow, even if the container were fully inverted).

Thus, in some aspects, fluid from the container will not enter or pass through the interior channel defined by support venting tube 120 (and, in these instances, fluid will similarly not pass through the perforated plate 113). In all instances, perforated plate 113 and venting tube 120 serve primarily and sometimes exclusively as return air management systems.

In summary, in addition to the specific features of the device and system (namely, the two piece flame mitigation device 100 and the long neck container 10, 10a), the inventors realized the dimensions and use of polymers help to contribute to the flame mitigation performance. Specifically, the slotted connector 110 strikes a balance between air-fluid flow conditions and by presenting a physical barrier, both of which enhance flame mitigation. The support tube 120 facilitates installation and insures proper positioning of the connector 110, while contributing to the balance of air-flow flow conditions.

In a first aspect, the invention comprises flame mitigation device. That device is received within an elongated container neck so as to be permanently affixed thereto after the device is installed. The device includes a slotted connector and a support tube. The slotted connecter defines a funnel along an inner lumen and has a retention element at an upper end, a tube retention feature at an opposing lower end, sidewalls including apertures extending axially between the retention element and the tube retention feature, and a perforated plate spanning the inner lumen where the sidewalls connect to the tube retention feature. The support tube has an upper end that is attached to the tube retention feature. Further iterations may include any one or combination of the following:
wherein the perforated plate includes a series of holes arranged across a top surface of the plate so as to define a cumulative open area on the top surface of the plate;
wherein a maximum inner diameter of the funnel is positioned along the inner lumen defined by the retention element so as to define an open surface area of the funnel along the maximum inner diameter;
wherein at least of the following applies: i) the cumulative open area on the inner surface of the sidewalls is 50% to 70% of a total area occupied by the solid members on the inner surface of the sidewalls, ii) the cumulative open area on the top surface of the perforated plate is 30% to 50% of the total area occupied by solid portions in the top surface of the perforated plate, and iii) wherein a sum of the cumulative open areas on the inner surface of the sidewalls and on the top surface of the perforated plate is between 80% to 95% of the open surface area of the funnel;
wherein the retention element comprises a radial flange having coupling features integrated therein;
wherein the radial flange includes a bottom surface that is inclined at an acute angle relative to the maximum inner diameter;
wherein the retention element comprises an upper sidewall inset form an annular ledge, wherein coupling features are integrated on one or both of the upper sidewall and the annular ledge and wherein a secondary perforated plate extends across the inner lumen between the upper sidewall of the retention element and wherein the secondary perforated plate defines a cumulative open surface area for the funnel;
wherein the sidewalls taper inward so that a minimum inner diameter of the funnel is positioned immediately above the perforated plate;
wherein the sidewall initially extend radially outward from the retention element to a maximum outer diameter and thereafter taper inward so that a minimum diameter of the funnel is positioned immediately above the perforated plate;
wherein the tube retention feature includes grooves along an outer surface of the tube retention feature, said grooves aligned with axial slots;
wherein the grooves includes through-apertures along all portions of the tube retention feature positioned below the perforated plate; and
wherein the support tube is formed with a dimensioned cut at a lower end opposite the upper end.

In a second aspect, the invention is a complete flame mitigation system that incorporates any of the aforementioned iterations of the flame mitigation device. This system also includes a container having an elongated neck so that the device is permanently coupled to an inner facing of an opening in the elongated neck. The support tube is configured to have an axial length so that a lower end of the support tube maintains contact with an inner bottom surface of the container. In some iterations, the container includes dual chambers connected in series by a connection tube and with flame mitigation devices installed at the opening of each chamber.

Still further aspects and iterations can be conceived pursuant to this disclosure, and the foregoing examples should not be considered as limiting in any way.

All components should be made of materials having sufficient flexibility and structural integrity, as well as a chemically inert nature. The materials should also be selected for workability, cost, and weight. Common polymers amenable to injection molding, extrusion, blow molding, or other common forming processes should have particular utility for forming the closure fitment/tamper evident panel as a single piece (as well as the cap and, when used, the mesh insert as separate pieces). Fluorination and/or irradiation may provide still more degrees of freedom in polymeric materials selection and treatments to impart desired qualities.

Certain grades of polypropylene and polyethylene are particularly advantageous, especially in view of the absence of any thermosetting resins, elastomeric polymer blends, and other chemically distinct polymers or copolymers (in comparison to the other components of the dispensing pump). Notably, high density polyethylene (i.e., having a density of greater than 0.940 g/cm³) may provide different characteristics in comparison to lower density polyethylene types (e.g., medium density at 0.925 to 0.940 g/cm³ and/or lower density at 0.880 to 0.925 g/cm³), as would specialized blends or copolymers capable of cross-linking for greater stiffness.

The design of interfaces and attaching/coupling components should be sufficient to create a minimum retention force of at least fifteen pounds (whether exerted from the top or the bottom of the closure lumen). Designs should also account for flame exposure times should exceed thirty seconds with a two inch flame without failure.

In view of the foregoing, a system and closure for mitigating propagation of flames is contemplated. The system includes the aforementioned components, which will deliver the various benefits described herein.

References to coupling in this disclosure are to be understood as encompassing any of the conventional means used in this field. This may take the form of snap-or force fitting of components, although threaded connections, bead-and-groove, and bayonet-style/slot-and-flange assemblies could be employed. Adhesive and fasteners could also be used, although such components must be judiciously selected so as to retain the recyclable nature of the assembly.

In the same manner, engagement may involve coupling or an abutting relationship. These terms, as well as any implicit or explicit reference to coupling, will should be considered in the context in which it is used, and any perceived ambiguity can potentially be resolved by referring to the drawings.

Although the present embodiments have been illustrated in the accompanying drawings and described in the foregoing detailed description, it is to be understood that the invention is not to be limited to just the embodiments disclosed, and numerous rearrangements, modifications and substitutions are also contemplated. The exemplary embodiment has been described with reference to the preferred embodiments, but further modifications and alterations encompass the preceding detailed description. These modifications and alterations also fall within the scope of the appended claims or the equivalents thereof.

What is claimed is:

1. A flame mitigation device received within an elongated container neck, the device comprising:
a slotted connector defining a funnel along an inner lumen, the slotted connector having a retention element at an upper end, a tube retention feature at an opposing lower end, sidewalls including apertures extending axially between the retention element and the tube retention feature, and a perforated plate spanning the inner lumen where the sidewalls connect to the tube retention feature; and
a support tube having an upper end that is attached to the tube retention feature.

2. The device according to claim 1 wherein the apertures in the sidewalls are formed as uniform and evenly spaced axial slots defined on either side by solid member and wherein the axial slots define a cumulative open area on an inner surface of the sidewalls.

3. The device according to claim 2 wherein the perforated plate includes a series of holes arranged across a top surface of the plate so as to define a cumulative open area on the top surface of the plate.

4. The device of claim 3 wherein a maximum inner diameter of the funnel is positioned along the inner lumen defined by the retention element so as to define an open surface area of the funnel along the maximum inner diameter.

5. The device of claim 4 wherein at least of the following applies: i) the cumulative open area on the inner surface of the sidewalls is 50% to 70% of a total area occupied by the solid members on the inner surface of the sidewalls, ii) the cumulative open area on the top surface of the perforated plate is 30% to 50% of the total area occupied by solid portions in the top surface of the perforated plate, and iii) wherein a sum of the cumulative open areas on the inner surface of the sidewalls and on the top surface of the perforated plate is between 80% to 95% of the open surface area of the funnel.

6. The device of claim 1 wherein the retention element comprises a radial flange having coupling features integrated therein.

7. The device of claim 6 wherein the radial flange includes a bottom surface that is inclined at an acute angle relative to the maximum inner diameter.

8. The device of claim 1 wherein the retention element comprises an upper sidewall inset from an annular ledge and wherein coupling features are integrated on one or both of the upper sidewall and the annular ledge.

9. The device according to claim 8 wherein a secondary perforated plate extends across the inner lumen between the upper sidewall of the retention element and wherein the secondary perforated plate defines a cumulative open surface area for the funnel.

10. The device according to claim 1 wherein the sidewalls taper inward so that a minimum inner diameter of the funnel is positioned immediately above the perforated plate.

11. The device according to claim 2 wherein the sidewall initially extend radially outward from the retention element to a maximum outer diameter and thereafter taper inward so that a minimum diameter of the funnel is positioned immediately above the perforated plate.

12. The device according to claim 2 wherein the tube retention feature includes grooves along an outer surface of the tube retention feature, said grooves aligned with axial slots.

13. The device according to claim 12 wherein the grooves includes through-apertures along all portions of the tube retention feature positioned below the perforated plate.

14. The device according to claim 1 wherein the support tube is formed with a dimensioned cut at a lower end opposite the upper end.

15. A flame mitigation system comprising a container having an elongated neck with the flame mitigation device of claim 1 permanently coupled to an inner facing of an opening in the elongated neck and wherein the support tube is configured to have an axial length so that a lower end of the support tube maintains contact with an inner bottom surface of the container.

16. The flame mitigation system of claim 15 wherein the container includes dual chambers connected in series by a connection tube and with flame mitigation devices installed at the opening of each chamber.

17. A flame mitigation system comprising a container having an elongated neck with the flame mitigation device of claim 5 permanently coupled to an inner facing of an opening in the elongated neck and wherein the support tube is configured to have an axial length so that a lower end of the support tube maintains contact with an inner bottom surface of the container.

18. The flame mitigation system of claim 17 wherein the container includes dual chambers connected in series by a connection tube and with flame mitigation devices installed at the opening of each chamber.

19. The device according to claim 11 wherein the tube retention feature includes grooves along an outer surface of the tube retention feature, said grooves aligned with axial slots.

20. The device according to claim 19 wherein the grooves includes through-apertures along all portions of the tube retention feature positioned below the perforated plate.
